(19) United States
(12) Patent Application Publication
(10) Pub. No.: US 2004/0074392 A1
(43) Pub. Date: Apr. 22, 2004

(54) Fixture type sterilizing and lighting apparatus

(76) Inventor: Joon Choi, Seoul (KR)

Correspondence Address: D. EDWARD DOLGORUKOV, MARSHALL & MELHORN, LLC, 8TH FLOOR, FOUR SEAGATE, TOLEDO, OH, 43604, US

(21) Appl. No.: 10/405,747

(22) Filed: Apr. 2, 2003

(30) Foreign Application Priority Data
Oct. 22, 2002 (KR) 2002-64409

(51) Int. Cl. B01D 46/00

(52) U.S. Cl. 96/224; 422/121; 422/186.3; 422/24

(57) ABSTRACT

The present invention provides a fixture type sterilizing and lighting apparatus provided together with a sterilizing apparatus and a lighting apparatus, so that it can accomplish a sterilization and an illumination concurrently by the same electric lamp, economize in energy and resources and solve one's double share in expenses. The fixture type sterilizing and lighting apparatus includes a ultraviolet electric lamp 1, 4, 22, 14 for emitting ultraviolet rays (wavelength of 253.7 nm); a fluorescent film 2, 5, 8, 15 formed with a fluorescent substance which emits the necessary rays such as visible rays, ultraviolet rays and infrared rays by the ultraviolet rays (wavelength of 253.7 nm) emitted from the above ultraviolet electric lamp 1, 4, 22, 14; a transparent tube or transparent plate 3, 6, 9, 16 coated with the above fluorescent film; (wavelength of 253.7 nm); and a reflection plate 17 for reflecting the ultraviolet rays (wavelength of 253.7 nm) emitted from the above ultraviolet electric lamp 1, 4, 22, 14, a blower 12, 20 for circulating a fluid gas or liquid, a dust removing filter 11, 19 for removing the dust in the fluid, a deodorizing filter 13, 21, and a base or case 7, 10, 18 for combining the above elements. The sterilization and illumination are concurrently accomplished by the same electric lamp and thus, energy and resources are economized. Further, since the sterilizing apparatus and the lighting apparatus are combined together, one's double share in expenses can be solved.

### FIELD OF THE INVENTION

The present invention relates to a fixture type sterilizing and lighting apparatus which can perform an illumination and sterilization concurrently and economize in energy. More specifically, the present invention relates to a fixture type sterilizing and lighting apparatus in which an ultraviolet electric lamp for emitting ultraviolet rays (wavelength of 253.7 nm) is provided in the inner portion, a transparent tube or a transparent plate coated with a fluorescent film consisting of a fluorescent substance which emits the necessary rays such as visible rays, ultraviolet rays and infrared rays by ultraviolet rays (wavelength of 253.7 nm) is provided in the outer portion, the ultraviolet rays (wavelength of 253.7 nm) emitted from the ultraviolet electric lamp sterilizes microorganisms existed in a fluid (gas or liquid) between an ultraviolet electric lamp and a fluorescent film, and the necessary rays such as visible rays, ultraviolet rays and infrared rays are emitted from the fluorescent substance of the fluorescent film coated on a transparent tube or a transparent plate provided in the outer portion, thereby an illumination and sterilization are concurrently performed and energy is economized.

### BACKGROUND OF THE INVENTION

In general, a lighting apparatus and a sterilizing apparatus using a discharge lamp have been manufactured by an independently separated mechanism and have come into wide use. However, when a lighting apparatus and a sterilizing apparatus using a discharge lamp are manufactured by an independently separated mechanism and have come into wide use, there are disadvantages, e.g., waste of energy, the squandering of resources and one's double share in expenses.

Further, in prior art references, a discharge lamp for lighting in the inner portion of one main body and an ultraviolet lamp for sterilizing are provided in series and in parallel, and if necessary, numerous techniques of radiating a selected one lamp or of radiating two lamps concurrently are reported.

These power on-and-off systems are selected from an artificial operation by switch or an automatic operation by sensor. However, because such construction has also two lamps, there still remain the problems as mentioned above.

### SUMMARY OF THE INVENTION

The purpose of the present invention is to solve the problems when a lighting apparatus and a sterilizing apparatus using a discharge lamp has been manufactured by an independently separated mechanism and has come into wide use, and to provide a fixture type sterilizing and lighting apparatus wherein the lighting apparatus and the sterilizing apparatus are constituted together using the same discharge lamp so as to economize in energy and resources and solve one's double share in expenses.

### BRIEF DESCRIPTION OF THE DRAWINGS

FIG. 1 is a view showing the principle of the present invention.

FIG. 2 is a view showing the first example using principle of the present invention.

FIG. 3 is a view showing the second example using the principle of the present invention.

FIG. 4 is a view showing the third example using the principle of the present invention.

### DESCRIPTION OF THE PREFERRED EMBODIMENT

In order to accomplish the purpose as mentioned above, the present invention provides a fixture type sterilizing and lighting apparatus wherein a discharge lamp for emitting ultraviolet rays (wavelength of 253.7 nm) with a potent sterilization power is provided in the inner portion of the apparatus, and a transparent tube or a transparent plate coated with a fluorescent film consisting of a fluorescent substance which emits the necessary rays such as visible rays, ultraviolet rays and infrared rays by the ultraviolet rays (wavelength of 253.7 nm) is provided in the outer portion of the apparatus.

That is, the fixture type sterilizing and lighting apparatus according to the present invention is characterized by including a ultraviolet electric lamp 1 for emitting ultraviolet rays (wavelength of 253.7 nm); a transparent tube or transparent plate 3,6,9,16 coated with a fluorescent film 2,5,8,15 consisting of a fluorescent substance which emits the necessary rays such as visible rays, ultraviolet rays and infrared rays by ultraviolet rays in the outer portion which is remote from the above ultraviolet electric lamp 1,4,22,14 in a certain distance.

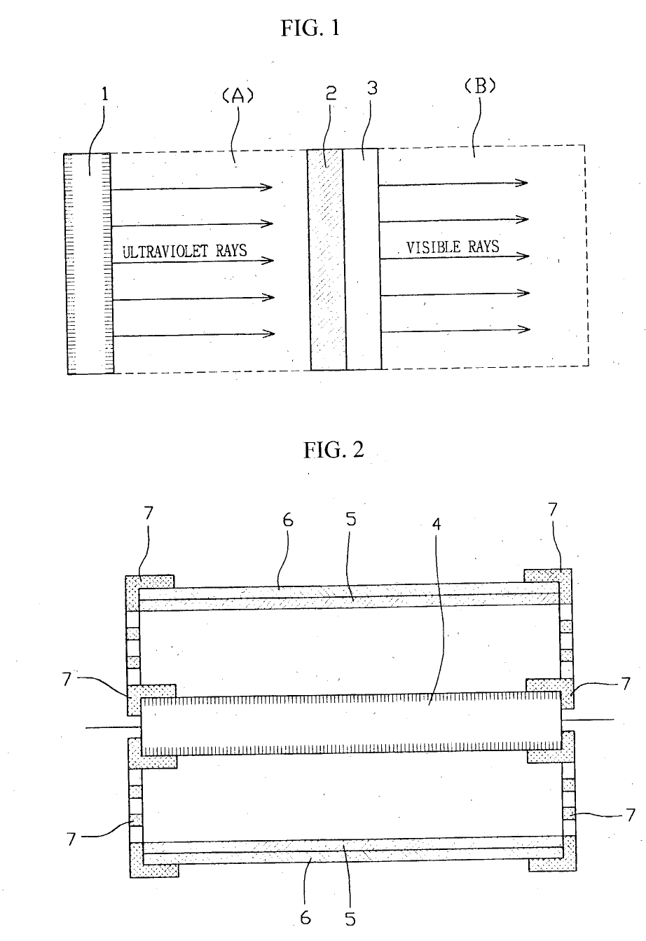

Hereinafter, the present invention is described in more detail with reference to the principle of the invention as shown in FIG. 1.

The ultraviolet rays (wavelength of 253.7 nm) emitted from an ultraviolet electric lamp 1 first sterilizes microorganisms existed in the fluid of the sterilizing region (A), and the ultraviolet rays (wavelength of 253.7 nm) which are neither used for sterilizing nor absorbed in the fluid of the region (A) arrives at the fluorescent film 2 formed with a fluorescent substance and excites the fluorescent substance presented in the fluorescent film 2. The fluorescent substance excited by ultraviolet rays (wavelength of 253.7 nm) transforms ultraviolet rays (wavelength of 253.7 nm) into the necessary rays such as visible rays, ultraviolet rays and infrared rays and then is emitted in the outer portion. The rays such as visible rays, ultraviolet rays and infrared rays emitted from the fluorescent film are illuminated to the lighting region (B) by transmitting a transparent plate 3.

Herein, the ultraviolet energy (wavelength of 253.7 nm) emitted from the ultraviolet electric lamp 1 is defined as E1, the energy used for sterilization as E2, the energy absorbed in the fluid as E3, the conversion energy of the rays such as visible rays, ultraviolet rays and infrared rays as E4 and the ray conversion rate of the fluorescent film as e. In this case, the equation is as follows:

E4=e(E1−E2−E3)

However, since E2 and E3 are very low in the case of air or water, E4≅eE1. Therefore, the fixture type sterilizing and lighting apparatus which can perform sterilization and an illumination concurrently using the same discharge lamp according to the principle of the present invention can more economize in energy and resources than each of the sterilizing apparatus and the lighting apparatus. The distance from ultraviolet electric lamp 1 to fluorescent film 2 is properly controlled considering the emitting amount of the necessary rays such as an absorption index of ultraviolet rays (wavelength of 253 nm), sterilizing ability, visible rays, ultraviolet rays and infrared rays of the fluid presented between the ultraviolet electric lamp 1 and the fluorescent film 2. For extending the life of product, preventing the lowering of quality and improving the efficiency of energy, the bonding substance for forming the fluorescent film 2 is selected from the materials having a high transmission factor of ultraviolet rays (253.7 nm) which are the materials not deteriorated by ultraviolet rays (253.7 nm).

In order to extend the life of product, prevent the lowering of quality and improve the safety of human body, the transparent plate 3 coated with a fluorescent film 2 uses the material not deteriorated by ultraviolet rays (wavelength of 253.7 nm) and the ultraviolet rays (wavelength of 253.7 nm) is not transmitted. The necessary rays such as visible rays, ultraviolet rays and infrared rays use the transmitted material. The properties of the rays emitted from the fluorescent film 2 are determined by controlling the composition and component of the fluorescent substances. The concentration and thickness of the fluorescent film is controlled so that the light efficiency is maximized.

Hereinafter, the present invention is described in more detail with reference to the first example of the attached FIG. 2.

The example illustrated in FIG. 2 is a fixture type sterilizing and lighting apparatus manufactured so that it can be used from a conventional lighting apparatus by applying to the principle of the present invention. The both ends of the ultraviolet electric lamp 4 and the transparent tube 6 coated with the fluorescent film 5 consisting of the fluorescent substance are integrally combined with a base 7 processed with an aperture so that the fluid can be passed through.

If the fixture type sterilizing and lighting apparatus is manufactured as shown above, the ultraviolet rays (wavelength of 253.7 nm) emitted from the ultraviolet electric lamp 4 sterilizes microorganisms presented in the fluid between the ultraviolet electric lamp 4 and the fluorescent film 5. The fluorescent substance in the fluorescent film 5 is excited by ultraviolet rays (wavelength of 253.5 nm) arriving at the fluorescent film 5, and emits the necessary rays such as visible rays, ultraviolet rays and infrared rays, thereby performs a sterilization and an illumination by the same discharge lamp as is accomplished in the present invention.

In order for the outer fluid to smoothly flow through the aperture without a separate apparatus between the ultraviolet electric lamp 4 and the fluorescent film 5, it is preferable to perpendicularly install so as to produce a chimney effect. Considering the relation of a smooth flow of the fluid and the contamination prevention of the ultraviolet electric lamp 4 and the fluorescent film 5 from a contamination material presented in the fluid, the aperture, a fluid flow hole of the base 7, is processed in a proper size.

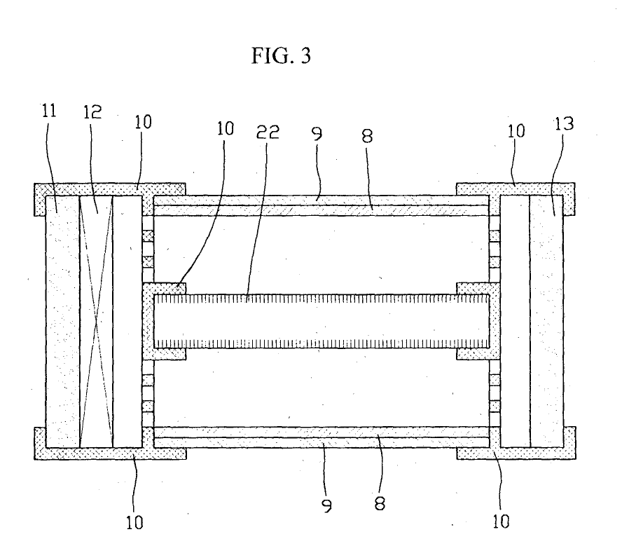

Further, the present invention is described in more detail with reference to the second example shown in the attached FIG. 3.

The example illustrated in FIG. 3 is a fixture type sterilizing and lighting apparatus to which the air-cleaning performance is added. One or a plurality of the ultraviolet electric lamps 22 is/are provided in the inner portion of the case 10, and the transparent tube or transparent plate 9 coated with the fluorescent film 8 consisting of a fluorescent substance is provided in the side section of the case 10. A dust removing filter 11 and a blower 12 inhaling an outer fluid are provided in one side end portion of the case 10, and the deodorizing filter 13 is provided in another side end portion.

If the fixture type sterilizing and lighting apparatus is manufactured as mentioned above, the fluid inhaled in the inner portion of the apparatus by the blower 12 removes a dust while passing through a dust-removing filter 11. The microorganisms existed in the inhaled fluid is sterilized by the ultraviolet rays (wavelength of 253.7 nm) emitted from the ultraviolet electric lamp 22. The ultraviolet rays (wavelength of 253.7 nm) arriving at the fluorescent film 8 coated in the transparent tube or transparent plate 9 excites the fluorescent substance in the fluorescent film 8 to thereby emit the necessary rays such as visible rays, ultraviolet rays and infrared rays. The odor remained in the fluid flowing out outside is removed by the deodorizing filter 13, thereby performs a sterilization and illumination by the same discharge lamp as is accomplished in the present invention.

Considering the kind of fluid, sterilization ability and air cleaning capability, the performance of a dust-removing filter, a deodorizing filter and a blower must be properly controlled, and the position of the ultraviolet electric lamp 22 is controlled so that the rays are uniformly emitted in the fluorescent film 8.

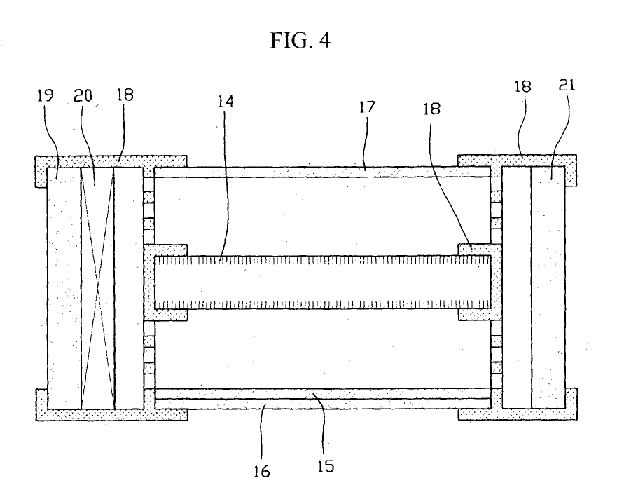

The present invention is described in more detail with reference to the third example of the attached FIG. 4.

The example illustrated in FIG. 4 is a fixture type sterilizing and lighting apparatus for illuminating by means of one side section only, differently from the examples of FIGS. 2 and 3 illuminating by means of all the side section. One or a plurality of ultraviolet electric lamp 14 is/are provided in the inner portion of the case 18, and the transparent tube or transparent plate 16 coated with the fluorescent film 15 consisting of a fluorescent substance is provided in one side section of the case 18. A reflection plate is provided in another side section of the case 10 wherein the transparent plate 16 is not installed. A dust removing filter 19 and a blower 13 for inhaling an outer fluid are provided in one side end portion of the case 10, and the deodorizing filter 13 is provided in another side end.

If the fixture type sterilizing and lighting apparatus is manufactured as mentioned above, the fluid inhaled in the inner portion of the apparatus by the blower 20 first removes a dust while passing through a dust-removing filter 19. The microorganisms existed in the inhaled fluid is sterilized by the ultraviolet rays (wavelength of 253.7 nm) emitted from the ultraviolet electric lamp 14. The reflecting plate provided to improve the efficiency of energy reflects the ultraviolet rays (wavelength of 253.7 nm) emitted from the ultraviolet electric lamp 14 in the side section of the fluorescent film. The ultraviolet rays (wavelength of 253.7 nm) arriving at the fluorescent film 15 coated in the transparent tube or transparent plate 16 excites the fluorescent substance in the fluorescent film to emit the necessary rays such as visible rays, ultraviolet rays and infrared rays. The odor remained in the fluid flowing out outside is removed by the deodorizing filter 21, thereby purifies the fluid and performs a sterilization and illumination by the same discharge lamp as is accomplished in the present invention.

The reflecting plate 17 provided to improve the efficiency of energy is manufactured so that the reflection factor of the ultraviolet rays (wavelength of 253.7 nm) is maximized and the rays are uniformly emitted from the fluorescent film 15.

According to the present invention as set forth above, the fixture type sterilizing and lighting apparatus wherein a sterilization and an illumination are concurrently performed by one electric lamp is provided, thereby the consumption power can be lowered to economize energy, the number of the parts can be reduced to economize resources, and the cost of manufacture is lowered to maximize the satisfaction of consumer. In addition, the product can be purchased to conform to the preference of consumer by differentiating the products as shown in various examples of the present invention.

What is claimed is:

1. A fixture type sterilizing and lighting apparatus characterized by including a ultraviolet electric lamp 1, 4, 22, 14 for emitting ultraviolet rays; a transparent pipe or transparent plate 3, 6, 9, 16 coated with a fluorescent film 2, 5, 8, 15, which emits visible rays, ultraviolet rays and infrared rays by the ultraviolet rays emitted from the above ultraviolet electric light; a base or case 7, 10, 18 which is installed remote from the above ultraviolet electric lamp and the transparent tube or transparent plate in a certain distance and forms an aperture so that the fluid can be circulated at the two end portions.

2. The fixture type sterilizing and sterilizing apparatus of claim 1 characterized in that a blower 12, 20 for circulating a fluid is provided in a certain portion of the inner of the case.

3. The fixture type sterilizing and sterilizing apparatus of claim 2 characterized in that a dust-removing filter 11, 19 for removing a dust of the fluid is included in a certain portion.

4. The fixture type sterilizing and lighting apparatus of claim 2 characterized in that a deodorizing filter 13, 21 for removing an odor of the fluid is included in a certain portion.

5. The fixture type sterilizing and lighting apparatus of claim 3 characterized in that a deodorizing filter 13, 21 for removing an odor of the fluid is further included in a certain portion.

6. The fixture type sterilizing and lighting apparatus of any one of claims 1 to 5 characterized by further including a reflecting plate 17 for reflecting ultraviolet rays emitted from the ultraviolet electric light.

7. The fixture type sterilizing and lighting apparatus of claim 2 characterized in that a picture is printed in the outer portion of the transparent tube or transparent plate or the printed picture is attached thereto.
